(19) United States
(12) Patent Application Publication
(10) Pub. No.: US 2005/0064901 A1
(43) Pub. Date: Mar. 24, 2005

(54) Downloading data files to mobile communication device via an optical communication link

(75) Inventors: Kenneth James Park, Portland, OR (US); Atsushi Ishii, Vancouver, WA (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/670,001

(22) Filed: Sep. 24, 2003

(51) Int. Cl. H04M 1/00; H04B 1/38

(52) U.S. Cl. 455/556.1; 455/550.1; 455/557

(57) ABSTRACT

A method of acquiring data filed in a mobile communication device, having data storage locations, wherein the mobile communication device includes an optical data capture mechanism, includes providing data in a computer readable form; determining if the data can be stored in a single graphics file; converting data to a graphic representation; and reading and storing the graphic representation with the optical capture mechanism in the mobile communication device.

### FIELD OF THE INVENTION

This invention relates to mobile communication devices, and specifically to a technique for incorporating a mobile communication device, a CCD camera, and a communication link therebetween.

### BACKGROUND OF THE INVENTION

There are instances where it is desirable to initialize or update a mobile computing device's, also referred to herein as a portable communication device (PCD), memory without the need for a physical or RF connection. Normally at a PCD's point-of-sales or servicing location, the device is provisioned by a customer service representative (CSR). The provisioning process requires the CSR to have access to a computer, a program specific to the PCD on that computer, and a PCD's specific data cable that connects the PCD to the computer. By providing a means to provision a PCD that does not require a computer, a computer program and a data cable, the provisioning process becomes less burdensome to the CSR.

U.S. Patent Publication No. 20020071067, of Yoshitoshi, for Blacklight and ;iquid crystal display apparatus using the same, published Jun. 13, 2002, discloses use of a scannable barcode display and a method for using the same, but does not disclose the use of a CCD camera as a dual use device on a cell phone, nor does the reference disclose the use of scanned data as intrinsic to the use and function of the cell phone.

U.S. Patent Publication No. 20010051915, of Ueno et al., for Data transfer system using mobile terminal and two-dimensional barcode, published Dec. 13, 2001, discloses a data transfer system using a mobile terminal and a two-dimensional barcode, and more particularly, a processing system, server, processing terminal, and communications terminal which may be used to pay for purchases and manage membership cards and admission tickets, and other services, however, the reference does not disclose the use of a CCD camera as a dual use device on a cell phone, nor the use of scanned data as intrinsic to the use and function of the cell phone

WO0227593, of Shin et al., for integrated customer management system and method using wireless barcode, priority date Sep. 29, 2000, discloses a system for use in a customer management system and method using LCD barcode displayed on mobile terminal, however, the reference does not disclose the use of a CCD camera as a dual use device on a cell phone, nor the use of scanned data as intrinsic to the use and function of the cell phone

EP0537522, of Fernböck, for Apparatus and method for collecting, possibly processing, storing and transmitting all kinds of data, priority date Apr. 21, 1993, describes an apparatus and method for collecting and manipulation data, wherein the collection terminal is housed in a unitary structure.

WO0157811, of Doherty et al., for Data Handling, priority date Feb. 2, 2000, describes a data handling device in the form of a mobile phone and a scanner of some unspecified type. A RF connection between a phone and a mobile system provides the ability to store scanned data at the phone and forward the data to mobile system, however, the use of a CCD camera as a dual use device on a cell phone nor the use of scanned data as intrinsic to the use and function of the cell phone is not described.

### SUMMARY OF THE INVENTION

A method of acquiring data filed in a mobile communication device, having data storage locations, wherein the mobile communication device includes an optical data capture mechanism, includes providing data in a computer readable form; determining if the data can be stored in a single graphics file; converting data to a graphic representation; and reading and storing the graphic representation with the optical capture mechanism in the mobile communication device.

It is an object of the invention to transfer data to a mobile device via an optical link.

Another object of the invention is to provide a protocol for updating data files in a mobile device without the need for a hard-wired or RF communication system.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the method of the invention.

FIG. 2 is a block diagram of an alternate embodiment of the method of the invention.

### DETAILED DESCRIPTION OF THE PREFERRED EMBODIMENTS

This invention provides a method of downloading date to a mobile computing device, e.g., cellular phone, PDA, etc., also referred to herein as a portable communication device (PCD), wherein the mobile communication device is equipped with an optical data capture mechanism, e.g., a CCD camera, and also provides an algorithm to interpret the data. A control process controls both the CCD camera and the interpretation algorithm. The control process may interact with the PCD's user interface to take input from, or provide feedback to, the user regarding the current state of the CCD and the interpretation algorithm. The control process also may respond to information embedded in the optical data.

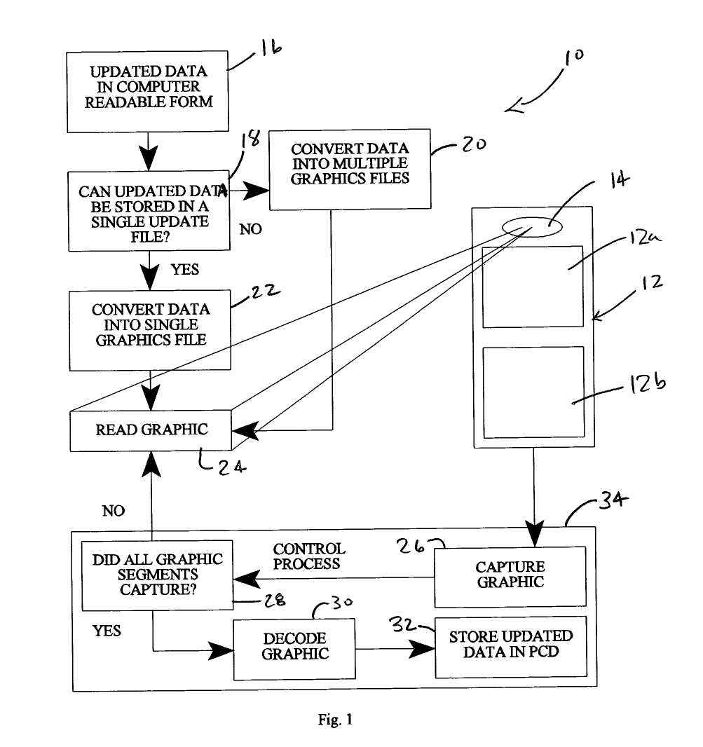

Referring now to FIG. 1, the method of the invention provides a protocol 10 for transferring data to a portable communication device (PCD) 12 without the need for a hard-wire or RF communication connection. PCD 12 includes a display 12a and a keypad 12b, and an image capture mechanism 14, such as a CCD camera. The example used herein provides a means for configuring a PCD's Preferred Roaming List (PRL) data file with new or updated data such that the PCD does not require a physical or RF connection as the data bearer. The PRL file contains data that defines how PCD 12 is to operate for a given wireless network. From time to time, a wireless network operator changes the PRL to reflect changes in the wireless network. For the PCD to work optimally, it must have the most current PRL for a given network.

The new data to be updated or stored in PDC, also referred to herein as a mobile communications device (MCD), 12 is first rendered in computer readable form, block 16. The method of the invention determines if the data can be stored in a single graphics file. If the data file is too large to fit into a single graphic file, NO to block 18, multiple associated graphics are used, and the data is converted into plural graphic files, block 20; otherwise, YES to block 18, the data is converted into a single graphic representation data file, block 22. In the method of the invention, the PRL data is converted into a graphical representation 24, e.g., bar-code. PDC 12 then reads and stores the graphic representation by reading the graphic representation with the optical capture mechanism, specifically, CCD camera 14 can capture, block 26, an image of the graphic and store it for later processing. The method of the invention then determines whether the graphic representation is successfully captured. If the capture is not successful, NO to block 28, the graphic is read again until the capture is successful, YES to block 28. This may be accomplished, in the case of multiple associated graphics, by informing the user that the nth of×total graphics was not decoded and the user should attempt to re-capture the nth graphic to complete the data file.

An algorithm of the method of the invention is applied to the stored graphic, to convert, or decode, 30 the encoded data back to a format that is suitable for the PCD's data filling system. The data is then stored, block 32, in the PCD's data file location. A control process 34 controls the CCD and the interpretation algorithm, and directs storage of the newly decoded PRL data into the PCD's file system, or data storage location, creating a new or overwriting an existing PRL data file.

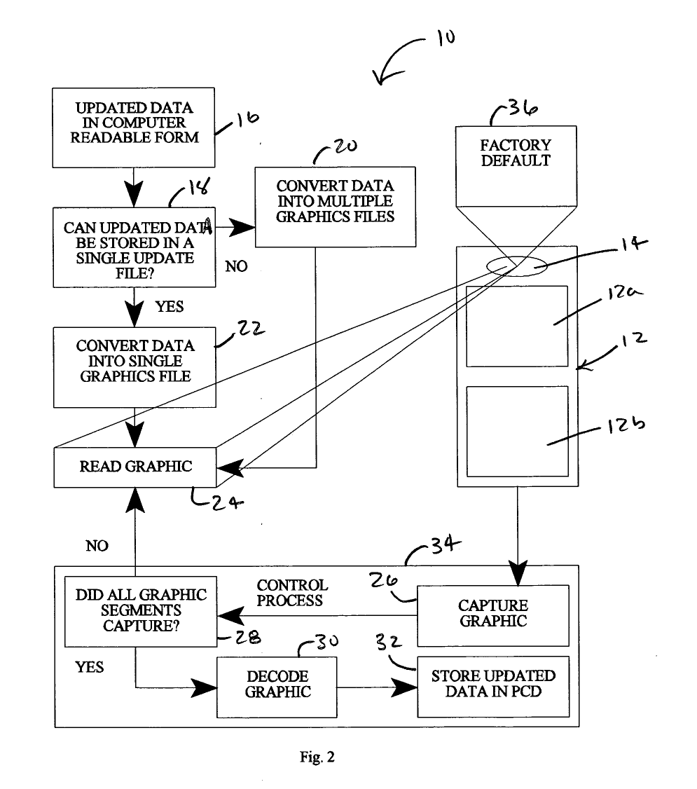

Another embodiment, depicted in FIG. 2, uses the factory default setting data file, block 36. The factory default setting data file is generally not part of a point of sales provisioning process, but rather occurs at the time of manufacture. It may be read by the optical capture mechanism to restore the PCD to factory default settings.

Another embodiment uses the Non-Volatile (NV) item data file. The NV item data file is generally not part of a point of sales provisioning process, but rather occurs at the time of manufacture. In this instance the graphic representing the NV item data may be unique in that the encoded data is specific to a single phone.

Thus, a method for downloading data files to mobile communication device via an optical communication link has been disclosed. It will be appreciated that further variations and modifications thereof may be made within the scope of the invention as defined in the appended claims.

1. A method of acquiring data filed in a mobile communication device, having data storage locations, wherein the mobile communication device includes an optical data capture mechanism, comprising:
providing data in a computer readable form;
determining if the data can be stored in a single graphics file;
converting data to a graphic representation; and
reading and storing the graphic representation with the optical capture mechanism in the mobile communication device.

2. The method of claim 1 which further includes, if data cannot be stored in a single graphic file, converting the data to plural graphic representations.

3. The method of claim 1 wherein said storing includes:
capturing the graphic representation;
determining if the graphic representation is successfully captures;
decoding the graphic representation; and
storing the decoded graphic representation in the mobile communication device's data storage location.

4. The method of claim 3, which further includes, if the graphic representation is not successfully captured, reading the graphic representation until capture is successful.

5. The method of claim 1 which further includes capturing a factory default setting graphic representation to restore factory default setting in the mobile communication device.

6. The method of claim 1 wherein the data is preferred roaming list data.

7. A method of acquiring preferred roaming list data filed in a mobile communication device, having data storage locations, wherein the mobile communication device includes an optical data capture mechanism, comprising:
providing preferred roaming list data in a computer readable form;
determining if the preferred roaming list data can be stored in a single graphics file;
converting the preferred roaming list data to a graphic representation; and
reading and storing the graphic representation of the preferred roaming list data with the optical capture mechanism in the mobile communication device.

8. The method of claim 7 which further includes, if preferred roaming list data cannot be stored in a single graphic file, converting the preferred roaming list data to plural graphic representations.

9. The method of claim 7 wherein said storing includes:
capturing the graphic representation;
determining if the graphic representation is successfully captures;
decoding the graphic representation; and
storing the decoded graphic representation of the preferred roaming list data in the mobile communication device's preferred roaming list data storage location.

10. The method of claim 9, which further includes, if the graphic representation is not successfully captured, reading the graphic representation until capture is successful.

11. The method of claim 7 which further includes capturing a factory default setting of the preferred roaming list data graphic representation to restore preferred roaming list data factory default setting in the mobile communication device.

12. A method of acquiring data filed in a mobile communication device, having data storage locations, wherein the mobile communication device includes an optical data capture mechanism, comprising:
providing data in a computer readable form;
determining if the data can be stored in a single graphics file;
converting data to a graphic representation;
reading the graphic representation with the optical capture mechanism in the mobile communication device;
capturing the graphic representation;
determining if the graphic representation is successfully captures;
decoding the graphic representation; and
storing the decoded graphic representation in the mobile communication device's data storage location.

13. The method of claim 12 which further includes, if data cannot be stored in a single graphic file, converting the data to plural graphic representations.

14. The method of claim 12, which further includes, if the graphic representation is not successfully captured, reading the graphic representation until capture is successful.

15. The method of claim 12 which further includes capturing a factory default setting graphic representation to restore factory default setting in the mobile communication device.

16. The method of claim 12 wherein the data is preferred roaming list data.
